(19) United States
(12) Patent Application Publication
(10) Pub. No.: US 2009/0250510 A1
(43) Pub. Date: Oct. 8, 2009

(54) Voting Method

(76) Inventor: Alexandr Nikiforovich Kondrashov, Rostov-na-donu (RU)

Correspondence Address: MEYER UNKOVIC & SCOTT LLP, 535 Smithfield Street, Suite 1300, Pittsburgh, PA, 15222-2315, US

(21) Appl. No.: 12/225,447

(22) PCT Filed: Sep. 19, 2007
(86) PCT No.: PCT/RU2007/000509

§ 371 Date: Sep. 22, 2008

(30) Foreign Application Priority Data
Sep. 28, 2006 (RU) 2006134345

(51) Int. Cl. G07C 13/00

(52) U.S. Cl. 235/51

(57) ABSTRACT

The invention relates to voting devices. The inventive method consists in identifying a voter who, afterwards, selects one of the voting options and simultaneously drops a voting ball in a vertical receiving transparent cylinder placed on a lighttight screen. The falling ball touches the end of the cantilever platform of a mechanical counter, which is fastened to the side surface of said cylinder and records on the digital display thereof the total number of casted votes, and afterwards, the end of the cantilever platform of a mechanical counter, which records on the digital display thereof the total number of voters who selected a specific voting option. The final voting results are determined by comparing the total number of recorded votes for each voting option with the total number of voters and with results of instrumental video monitoring. The voting results are afterwards published. Said invention makes it possible to increase the reliability and credibility of a voting procedure.

### CROSS REFERENCE TO RELATED APPLICATION

This application is a national stage filing under 35 U.S.C. § 371 of International Application No. PCT/RU2007/00509, which claims priority to Russian Application No. 2006 134 435, filed Sep. 28, 2006, incorporated by reference in its entirety herein.

### FIELD OF INVENTION

This invention relates to voting methods which may be used for conducting referendums, elections at various levels, stockholders' meetings, etc., and also for automated voting systems, including the State automated system of the Russian Federation Elections.

### BACKGROUND OF THE INVENTION

As is known, the elections of the president, the parliament members, governors, prefects, city mayors, and village headmen, and also meeting members, in accordance with the Law on the Election to the Public Institutions, are conducted in the following way. The bodies of local administration send to their voters cards which serve as tickets to the polling places. The voter brings the card with him/her to the polling station, where his person is identified by checking it against the list of voters, and he/she is given thereof a voting paper (ballot).

The voters fill in the voting paper ballot (the ballot for voting at referendums), drop the ballot into the ballot box, and thus finish the polling act. The ballot boxes are taken to certain places (gyms, etc.) to carry out the calculation of votes according to the method of calculation of the elected candidates, indicated in the ballots.

At present for voting, as a rule, the simplest accumulators of voting papers are used, and the votes are calculated by hand, and the procedure of counting the votes may last for many hours. This is especially critical, and there is a need for minimizing the time of counting the votes, at stockholders' meetings, where the results of voting must be announced before the meeting closes. The voting procedure also allows conducting second (repeated) voting and reclamation. Voters at a stockholders' meeting have different number of “voting” shares and they can vote based on their share. All of these circumstances make the procedure of counting votes rather long and labor-intensive.

Well known is the method involving the paper voting ballots and the voting ballots for referendum (Article 52 of the Federal law of Sep. 19, 1997 124FL, “On the main guarantees of the election rights for taking part in referendum by the RF citizens”).

The voting method (voting ballots for referendum) is based on manual operations and the use of paper ballots: the information is input by way of filling in the paper ballots (voting ballots for referendum) and counting the votes and the referendum participants.

European Patent No. 0229580 (1987) and the RF Patent No. 2172981 of Oct. 28, 1999, G07C 13/00, B07C 5/10 is known as “The method of automatic processing of ballots, device for carrying out this method, and the scanner of voting ballots” (inventor: B. L. Boborovnikov).

The patents mentioned above use a well known technique (method) of scanning, and automate some manual operations in voting, including the input of information and counting the votes. The main drawbacks of these methods are large organizational and material losses in the preparation and conducting of elections and referendums. Other drawbacks include low reliability, trustworthiness and a lack of confidentiality of the voting process.

Patent RU No. 2206124 of Jun. 10, 2003, G07C 13/00 is known as “Automatized system of voting” (inventors: V. A. Arkhipov, V. M. Ivanov, A. N. Ignatjev, et al.). It uses automated devices for storing voting ballots, processing the video information, a device for reading ballots, locking device, declinatory device, object-glass, videocamera, elevating device, video commutation device, control card and four photosensors.

Patent RU No. 2265887 of Mar. 19, 2003, G07C 13/02 is known as “The method of automated processing of voting ballots and the device for its implementation” (assignee: PC “LOMO”, St-Petersburg), and describes putting voting ballots into a channel and moving them along the channel, reading simultaneously their image in the full width on both sides of the sheet, identifying the voters' marks and qualifying the voting ballots with simultaneous marking of invalid ballots.

Patent RU No. 2212056 of 10.09.2003, G07C 13/00, “Voting method based on the use of electronic ballots” (inventors: A. A. Veshniakov, V. V. Omelchenko, L. J. Petrenko), provides an electronic device for identification for each voter and confirms his right to vote. The voter puts the electronic device into a computer in the polling booth, which results in activating the voting program.

Well known are systems for counting votes, such as those described in DE, A1, 4000133 G07C 13/00, Jul. 11, 1991; WO 91/01333, G07C 13/00, Feb. 21, 1991; U.S. Pat. No. 3,793,505, G07C 13/00, Feb. 19, 1974.

Patent RU No. 2242793 of Dec. 20, 2004, G06F 17/40, “The Method of Electronic Voting” (inventor: N. A. Nikishin), discloses a method of electronic voting where all operations involved in the method are accomplished with the help of the client/server software.

Also known are the voting methods which have not been tested in real elections:
use of the radio (patent RU No. 2144655 of Jan. 20, 2000, G07C 13/00 “The method of public-opinion poll, the system for its application and a subscriber's device for putting in the data” (inventors: V. A. Shevtsov, N. A. Neudobnov, A. G. Terekhin);
use of television (patent RU No. 2181910 of Apr. 27, 2004, G07C 13/00, H04Q 3/00 “Method and device for televoting in intellectual net” (assignee: Nokia Telecommunications Oj, Finland).

A technical solution is most closely found in the voting method accomplished with the use of an “Electronic Voting Machine” (EVM), (www.belindia.com/Website/Asp/ProductDetails.asp?Category, Id=65 and Product Id=138), in which a voter is registered by the clerk at the polling station and goes to a special polling booth where the voting machine is located. He/she chooses the candidate according to the list of candidates displayed on the information field of the voting cantilever, and pushes a button on the voting cantilever corresponding to the chosen candidate. The choice is recorded in the memory of the voting machine. After the voter has left the polling booth, a clerk refreshes the machine by pushing an appropriate button on the control device of the voting machine.

When the elections are over, the voting machine is sealed and transferred to the Central Election Polling Station. It is only here that by way of pushing an appropriate button on the voting machine that the officials will find out the elections results.

Known voting methods do not completely eliminate the problems of improving the reliability, trustworthiness and the confidentiality of the voting process.

### SUMMARY OF THE INVENTION

The tasks of application of the voting method of the present invention are:
to reduce the amount of time and cost involved in preparing for and conducting an election and summing up the voting results;
to expand the awareness of the population about the election campaigns at every stage of the election process and every stage of referendums;
to minimize the influence of subjective human factors (intentional or accidental mistakes, etc.) upon counting the votes.

The said method makes it possible to increase the reliability and credibility of a voting procedure, and also to improve its confidentiality.

Some definitions:

1. The subject of will—voter, citizen of the country possessing the right to vote, or the participant in referendum, possessing the right to take part in referendum, etc.

2. The object of will—candidate (candidates) or a list of candidates, in whose favor the choice was made, or the wording of the question (questions), which was selected by the voter, etc.

3. Rights of the subject of will—election rights, implying the right to elect and to be elected, and also the right to participate in referendum, implying the constitutional right of the citizens of the country to participate in the referendum of this country, the subjects of the country, local referendum.

4. Voting committee—election committee or referendum committee, a collective body which is formed within the period of time and the order specified by the law, and whose function is to organize and perform the preparatory work, and also conduct the elections, or prepare and conduct referendums.

5. Offers for the will—a list of candidates or the wording for a question (questions), out of which the voter must select, made in print in the language of the voters.

6. Identification of the subject of will—the procedure of identification of appropriate documents, which legally prove the identity of the voter, and also prove the presence of appropriate identification of the voter on the list of the voting committee, carried out by the members of the voting committee.

7. Creating the voting results—the actions of the voter, which express the will of the voter, impartially recorded by technical means (for example, by at least one mechanical irreversible meter and a video camera) and formalized by the voting committee in accordance with established procedure in the form of a protocol of counting the number of voters, who have made their choice in favor of each of the objects of will (candidates) or a certain wording of the question (questions) of the referendum.

The tasks set are solved, whereas the technical result is achieved due to the fact that in the voting method, which provides identification of a voter, introduction of the list of candidates to the voter, selection by the voter of one of the voting options, creation of voting results, and the voting procedure being in line with the law and other bills, registration and publishing the voting results, each of the voter creates voting results, carried out by the ball.

### DETAILED DESCRIPTION

In the present invention, voting is accomplished by means of a simple device, which is described as follows:

A voter turns a candidate-information block to an observation sector in the bearing unit by turning the block around the vertical axle of the bearing unit. The bearing unit permits the candidate-information block to turn discretely to a plurality of positions in any direction. Turning the candidate-information block also turns the transparent ball-receiving cylinder so that the reach-through hole for the ball corresponds to the candidate shown in the observation sector. The transparent cylinder has at least one mechanical counter which can register on a digital display the impact of the ball upon the counter.

An election official places the ball in the initial position from the receiving basket into the feeding basket, and then a voter drops the ball into a vertical receiving transparent cylinder. Falling easily inside the cylinder, the falling ball touches the end of the cantilever platform having a first counter, which can be at least one mechanical counter, which records on its digital display the total number of voters. The falling ball then touches the end of the cantilever platform having a second counter, which can be at least one mechanical counter, which records on its digital display the total number of voters who selected a specific voting option. Thereafter the ball goes into a receiving chute.

Finally, the voter who has just voted or an election official turns the candidate-information block to an arbitrary position to initialize the candidate-information block for the next voter.

The voting results are counted by reading the information on each of the first and second mechanical counters. The total across all counters is exactly equal to the number of voters, and the final voting results are determined by comparing the total number of recorded votes for each voting option with a total number of voters and the results of instrumental video monitoring, and the voting results are afterwards published.

It should be noted that the instrumental video control may be carried out during the whole voting procedure and the materials of video control are used when needed, for example, for court examination.

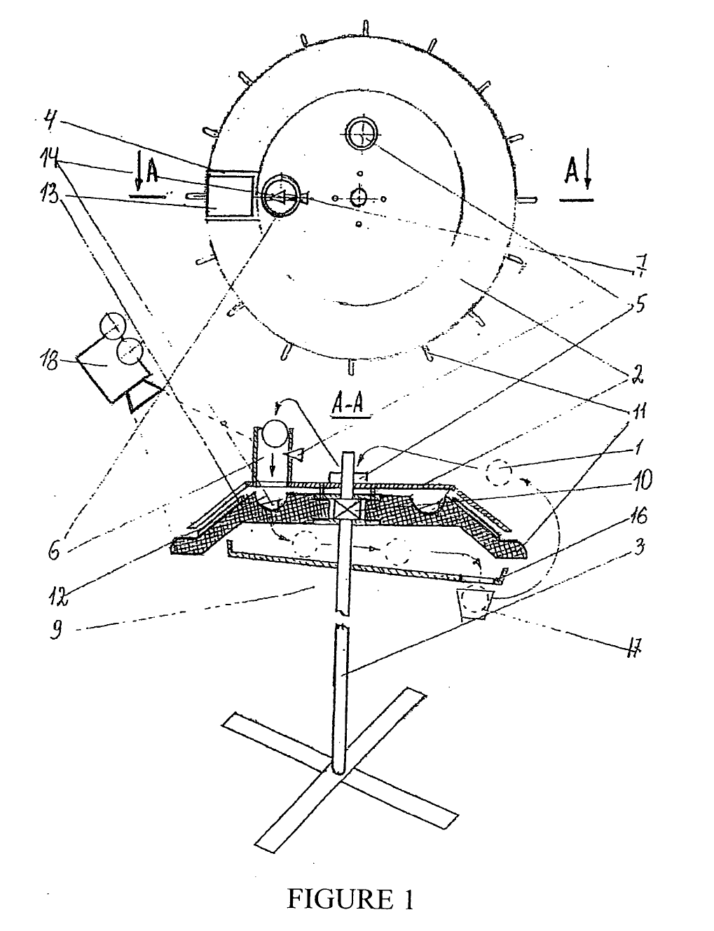

Hereafter the present invention is explained by a specific example of its realization as shown in FIG. 1, as follows:

A voting device, which carries out the said voting method, includes a voting ball 1; light-proof screen 2, firmly fixed on the vertical bearing axle 3, with the observation sector cut 4; feeding basket 5, firmly fixed on the light-proof screen 2; transparent leading receiving cylinder 6, firmly fixed on the light-proof screen 2 in such a way, that its rotation axle would go through the symmetry axle of the observation sector cut 4; at least one mechanical counter 7, fixed in the cut on the side surface of the transparent leading receiving cylinder 6, which carries out the counting of the total number of voters who have cast votes, the counter having a cantilever platform (not shown in the picture), providing the perception of each impact of the dropping ball; candidate-information block 9, made in the form of a truncated pyramid, which is able to revolve around the vertical bearing axle 3, including a bearing unit 10, with a firmly fixed set of spokes 11 with special holes 12 for the dropping ball pass 1, the number of holes being equal to the number of candidates, a group of voting options (voting) 13, written in type font in the language of voters, including the Braille system, firmly fixed on spokes 11, and a group of mechanical counters 14, the number of which is equal to the number of candidates, firmly fixed on spokes 11, supplied with cantilever platforms 15 (not shown in the picture), for perceiving the impact of the falling ball 1; receiving chute 16; receiving basket 17, located under a special cut in the receiving chute 16; and a special video camera 18, which allows video observation of the voting procedure (dropping of the ball 1 inside the transparent leading receiving cylinder 6), of the contents (text) of one of the group of voting options 13 and the display of one of a group of mechanical counters 14.

The said voting device works as follows:

After the representatives of the voting committee have identified the voter, the latter receives permission to vote.

The voter hereafter comes to the voting device and consecutively through the observation sector cut 4 of the light-proof screen 2 he/she gets familiarized with the voting options 13, firmly fixed on the spokes 11. Through the observation sector cut 4 the voter sees in turn all of the voting options 13. After one of the options is chosen 13, the position of the candidate-information block 9 at that option is precisely fixed due to the discrete revolution of bearing unit 10.

An election official places the ball 1 into the feeding basket 5.

The voter takes the ball 1 from feeding basket 5 and drops it into the transparent leading receiving cylinder 6, from which the ball 1, falling under the impact of its own weight, affects the cantilever platform 8 of the first at least one mechanical counter 7, fixed in the cut on the side surface of the transparent leading receiving cylinder 6, which carries out counting of total number of voters who have cast votes. The ball 1 goes through the sector observing cut 4 of the light-proof screen 2 onto one of the cantilever platforms 15, firmly connected with a second at least one mechanical counter 14, which corresponds with the selected candidate, fixing the choice of a particular voting option 12, and goes into receiving chute 16.

Then a voter who has finished voting or an election official turns the candidate-information block 9 around the bearing axle 3 with the help of one of the spokes 11 to bring the latter into the initial position for the next voter. In this way, the next voter cannot identify the preceding position of the candidate-information block 9.

The main advantages of the present invention are
Raising the trust on the part of the participants in the elections (the voters, participants in referendums, members of district election committees, referendum committees, members of the higher election boards, observers and representatives of mass media) to the results of free voting at elections and referendums;
Raising the level of publicity in the activities of the election committees and referendum committees;
Raising the efficiency of presentation to mass media, to higher organs in election committee and referendum committee of data about opening of polling stations, the course of election, the voting results;
Reducing the costs of elections and referendums;
Raising the trustworthiness of the voting outcomes be preventing distortions in the voting results, by one of the voters or the persons interested, during the elections or referendums, and preventing forgery and entering false information about voting.

Importance of distinctions and advantages of the said invention call forth the technical solutions listed below, allow on the whole to increase the reliability and credibility of a voting procedure and also to raise the level of its confidentiality:

1. The use of one and the same ball for voting, given out by a member of the committee (district election committee or referendum committee) to each person who has come to the polling station to perform his action as a voter, who is included in the list of voters (referendum participants) and has identified himself/herself by producing an appropriate identification document, that ensures multiple voting and simplification of the voting procedure.

2. The application in the voting device of a leading transparent receiving cylinder, through the transparent walls of which the voter sees the dropping ball during the voting, which permits the voter to see the successful completion of voting.

3. The use in the voting device of a special video camera, which simultaneously registers the fact of successful voting (the fall of the ball through the transparent leading cylinder), the text of the selected voting option and the display of the second at least one mechanical counter with the number of voters who have selected a particular voting option, enables the election committee to get true information about the number of voters who participated in voting, and about the number of votes given to each particular candidate, registered by appropriate mechanical counters, and also by video camera. Thus, the ability to obtain true information about voting both in a recorded form and in the real time scale is realized.

4. Application in the voting device of a protective light-proof screen, firmly fixed on the vertical bearing axle, with an observation sector cut, which permits reliable confidentiality of the voting process.

5. The use in the voting device of a special bearing unit, ensuring discrete revolutions of the candidate-information block around the bearing axle.

Thus, the said voting method with the use of the ball for voting may be considered as a new approach in principle for the organization of voting during elections, referendums and different meetings.

The advantages of the said method as compared to the prior art are:

1. Simplicity, quick results, reliability and trustworthiness of the voting process, thus resulting in a high economic efficiency of the said voting method.

2. Raising publicity about the activities of election committees. The application of a standard technical solution based on the using mechanical counters and also standard video cameras provides a developed information infrastructure for the election system (availability of communication channels, data-processing nets in the regions, etc.) and which is quick and available for public coverage of the election committees' activities.

3. A high degree of trustworthiness and protection of voting during the elections and referendums. The application of the said voting method allows using well known, approved methods of information protection from deliberate distortions.

4. An increase in the efficiency of data collection for election and referendum processes. The application of the said voting method allows, providing the voting information structure is well developed, e.g. telecommunication channels of State computer-based system of the Russian Federation “Vibory” (“Elections”), an increased efficiency in the collection and submission of information to higher rank election committees and the referendum committees concerning the opening of polling stations, voting performance and the voting results.

The realization of the said method permits:
a reduction in the costs of, and time needed for voting preparation procedures, carrying out voting and sizing up voting results.
the creation of new possibilities in election campaign procedures (e.g., monitoring of election and referendum processes, the analysis of election procedures, etc.);
an improvement in the performance of automated election procedures (e.g., making up the list of voters, counting the votes, sizing up the preliminary and final voting results, ensuring availability of reference legal information, etc.);
automation of the work of polling stations;
increasing the awareness of the population about election campaigns at all stages of the election process or referendum;
minimization of the influence of subjective human factors (deliberate and accidental mistakes, etc.) upon summing up the voting results;
increasing the electorate trust in the voting results.

In the year of 2006 a working model of the voting device was made and tested during the voting procedure at the joint stock company PC “The Glass of Kajali” (Rostov-on-Don), which proves the efficiency and effectiveness of the said method.

What is claimed is:

1. A voting method consisting of identifying the voter, familiarizing him with the voting options, including the Braille system, selection by the voter of a voting option, creating the voting result, and, provided the voting procedure is held in accordance with the law and other legal acts, the registration and publication of voting results for public. Each voter creates a voting result with the help of a ball. The candidate-information block is brought to the observation sector by revolving it around the vertical axis of the bearing unit. The bearing unit permits the candidate-information block to revolve around the bearing unit to a plurality of discrete positions in any direction. It is fixed in such a way that it ensures the consecutive movement of the ball from the transparent receiving cylinder via the observation sector, the reach-through hole in the marked sector of candidate-information block selected by the voter, the cantilever platform of at least one counter corresponding to this sector, fixing in its digital display the fact of impact of the ball upon the counter of the number of voters who selected a particular voting option. Subsequently, the ball is brought into the initial position from the receiving basket to the feeding basket by an election official, and each of the voters drops the ball into the vertical receiving transparent cylinder, falling free inside which, the ball touches the cantilever platform of at least one mechanical counter, fixing on its digital display the total number of voters who have voted, then the cantilever platform of at least one mechanical counter, fixing in its digital display the fact of impact of the ball on at least one mechanical counter of the number of voters who have selected a particular voting option, and further on it gets into the receiving chute, after that the voter who has voted or an election official turns the candidate-information block to an arbitrary angle to bring it into its initial position for further voting. Registration of the voting results is carried out by taking the information from each mechanical counter, the number of which strictly corresponds to the number of candidates, and the data of which registers the number of voters who have selected a particular voting option, and at least one mechanical counter, the data of which registers the total number of voters. And the final voting results are determined by comparing the registered results on each candidate to the total number of voters and the results of the instrumental video control, and are prepared for publication of voting results for general knowledge.
